(19) United States
(12) Patent Application Publication
(10) Pub. No.: US 2014/0043583 A1
(43) Pub. Date: Feb. 13, 2014

(54) Embeddable Eyewear Cleaning Cloth and Housing

(71) Applicant: Patrick McCrory, Altadena, CA (US)

(72) Inventor: Patrick McCrory, Altadena, CA (US)

(21) Appl. No.: 13/951,102

(22) Filed: Jul. 25, 2013

Related U.S. Application Data
(60) Provisional application No. 61/681,753, filed on Aug. 10, 2012.

(51) Int. Cl. G02C 11/00

(52) U.S. Cl. CPC G02C 11/00
USPC 351/158

(57) ABSTRACT

An embeddable eyewear cleaning cloth and housing apparatus for a pair of eyewear. The apparatus comprises a housing defining an interior cavity and an opening providing access to and from the interior cavity. The housing is adapted to be secured to a pair of eyewear. A sheet of cleaning cloth material is disposed within the housing and is at least partially removable from the housing through the opening.

### CROSS-REFERENCE TO RELATED APPLICATIONS

This application claims the benefit of U.S. Provisional Patent Application No. 61/681,753, filed on Aug. 10, 2012, which is incorporated herein in its entirety by reference.

### STATEMENT REGARDING FEDERALLY-SPONSORED RESEARCH OR DEVELOPMENT

Not Applicable

### BACKGROUND OF THE INVENTION

1. Field of Invention

The present general inventive concept relates to eyewear, and more particularly, to an eyewear cleaning cloth which is embedded in a pair of eyewear.

2. Description of the Related Art

Eyewear incorporating one or more transparent (or at least translucent) lenses which, when properly worn, position the lenses in front of the eyes of a user, such that the user may look through the lenses, are known in the art. Various eyewear exists to accomplish a number of functions, such as for example to correct vision problems; to shield the eye and surrounding area from excessive light, wind, or impact from foreign objects; to filter certain wavelengths of light, for example to improve visual acuity in certain situations; or to provide an aesthetically-pleasing appearance.

In the field of eyewear, it is known to use a cloth to clean the lenses of eyewear, for example to remove dirt, dust, fingerprints, liquids, etc., from forward and rear surfaces of the lenses. However, many types of eyewear lenses are prone to scratching or other damage if cleaned using a cloth that is too coarse in texture. Accordingly, numerous specialized eyewear lens cleaning cloths are available which are fabricated from particularly smooth and soft cloth material, such that the cleaning cloths are less likely to scratch and damage eyewear lenses. In fact, optometrists and eyewear manufacturers often recommend that certain types of eyewear lenses only be cleaned using specialized eyewear lens cleaning cloths of the type described above.

The above-discussed eyewear lens cleaning cloths are typically manufactured separate from eyewear. Accordingly, such cleaning cloths require an eyewear user to carry a cleaning cloth along with their eyewear. Such cleaning cloths are bulky, and the user may forget to bring their cleaning cloth with them. Accordingly, an eyewear user may often be in a situation in which the lenses of the user's eyewear need to be cleaned and no eyewear lens cleaning cloth is readily available. Such a situation may prompt the user to clean the user's eyewear using a coarser material, which as discussed above, is ill advised. It is therefore desirable to introduce a cleaning cloth which is embedded into a pair of eyewear so that the user of the eyewear is able to carry a proper cleaning cloth with them wherever they go, without needing to carry two separate items. Furthermore, it is desirable to introduce a pair of eyewear having a cleaning cloth embedded therein such that the cleaning cloth is not readily visible to an observer of the eyewear.

### BRIEF SUMMARY OF THE INVENTION

According to several features of the present general inventive concept, an embeddable eyewear cleaning cloth and housing apparatus may be provided for use with a pair of eyewear. The apparatus may comprise a housing defining an interior cavity and an opening providing access to and from the interior cavity. The housing may be adapted to be secured to a pair of eyewear. The apparatus may further comprise a sheet of cleaning cloth material disposed within the housing and at least partially removable from the housing through the opening. In one embodiment, the apparatus may further include a spool received within the housing, the sheet being wound about the spool. The spool may be rotatably secured within the housing. In certain embodiments, the sheet may have a first end secured to the spool and a second end protruding through the opening. The apparatus may further include a tab secured to a second end of the sheet, the tab being sized to limit receipt of the tab through the opening into the housing interior.

In some embodiments, the apparatus may include a spring-loaded mechanism associated with the spool, the spring-loaded mechanism allowing rotation of the spool from an initial position of the spool and biasing the spool toward the initial position. The apparatus may further include a rotatable handle secured to the spool, whereby rotation of the rotatable handle results in rotation of the spool, thereby allowing winding or unwinding of the sheet about the spool. The apparatus may further include a fastener for securing the housing to a frame of a pair of eyewear. The fastener may, in some embodiments, be defined by an elongated rail sized and shaped to be received within a groove defined by a frame of a pair of eyewear. The fastener may be configured to allow the housing to be secured to an interior surface of a frame of a pair of eyewear such that the eyewear at least partially conceals the housing from view external of the eyewear.

According to certain embodiments of the present general inventive concept, a pair of eyewear may be provided which incorporates an embeddable cleaning cloth and housing. In certain embodiments, the eyewear may comprise a frame for holding at least one at least semi-transparent lens to an eye of a user, a housing secured to the frame, the housing defining an interior cavity and a first opening providing access to and from the interior cavity, and a sheet of cleaning cloth material disposed within the housing and at least partially removable from the housing through the first opening. In some embodiments, the housing may be disposed along an interior surface of the frame. The frame may define a rim portion and an intersecting temple arm portion, and the housing may be disposed proximate the intersection between the rim portion and the temple arm portion of the frame. The frame may define a second opening overlying the first opening of the housing, and the sheet may be at least partially removable from the housing through the overlying first and second openings.

In some embodiments, the eyewear may further include a spool received within the housing, the sheet being wound about the spool. The spool may be rotatably secured within the housing. The sheet may have a first end secured to the spool and a second end protruding through the opening. A tab may be secured to a second end of the sheet, the tab being sized to limit receipt of the tab through the opening into the housing interior. A spring-loaded mechanism may be associated with the spool, the spring-loaded mechanism allowing rotation of the spool from an initial position of the spool and biasing the spool toward the initial position. In some embodiments, a rotatable handle may be secured to the spool, whereby rotation of the rotatable handle results in rotation of the spool, thereby allowing winding or unwinding of the sheet about the spool.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a perspective view of a pair of eyewear incorporating one embodiment of an embeddable eyewear cleaning cloth and housing according to several features of the present general inventive concept;

FIG. 2 is a perspective view of the eyewear of FIG. 1; and

FIG. 3 is a front elevation view of the eyewear of FIG. 1, showing a user using the eyewear cleaning cloth.

### DETAILED DESCRIPTION OF THE INVENTION

Reference will now be made to example embodiments of the present general inventive concept, examples of which are illustrated in the accompanying drawings and illustrations. The example embodiments are described herein in order to explain the present general inventive concept by referring to the figures. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art.

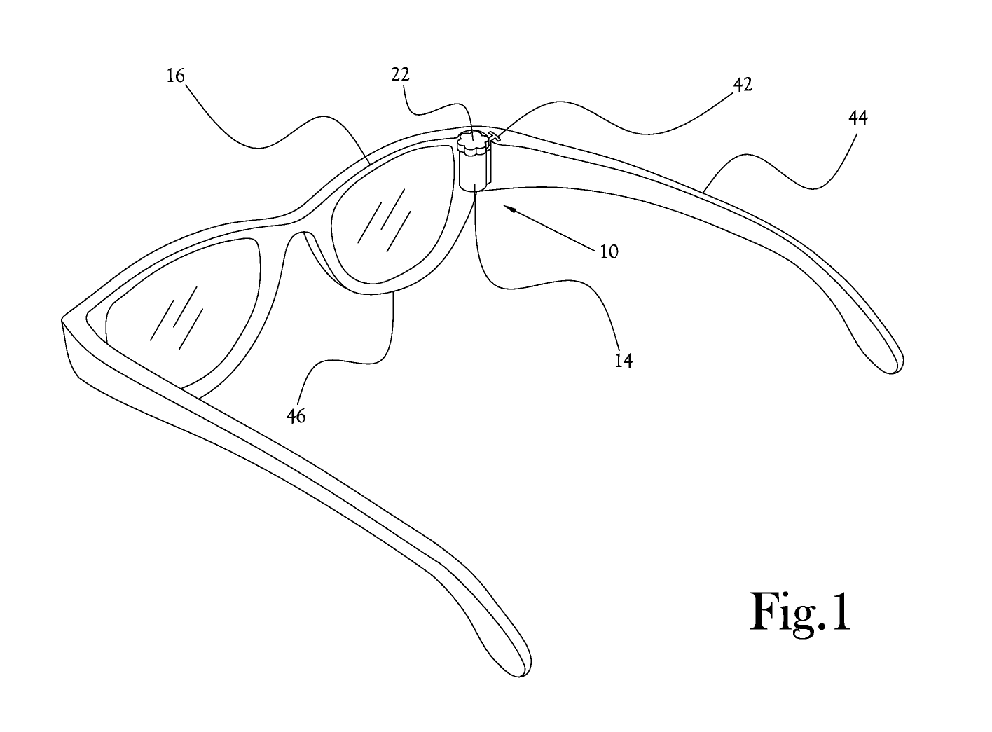

In accordance with various embodiments of the present general inventive concept, an embeddable eyewear cleaning cloth and housing apparatus is provided which is capable of being secured to a pair of eyewear to provide a cleaning cloth for the lenses of the eyewear which is accessible from the eyewear. The embeddable eyewear cleaning cloth and housing apparatus, or “apparatus,” is illustrated generally at 10 in FIG. 1. With reference to FIG. 1, the apparatus 10 includes generally a sheet of flexible cleaning cloth material 12 which is receivable within and retrievable from a housing 14. As will be further described below, the housing 14 is securable to a frame 16 of a pair of eyewear 18, and in more discreet embodiments, is securable to an interior surface of the frame 16, such that the housing is not readily visible from an exterior side of the eyewear 18.

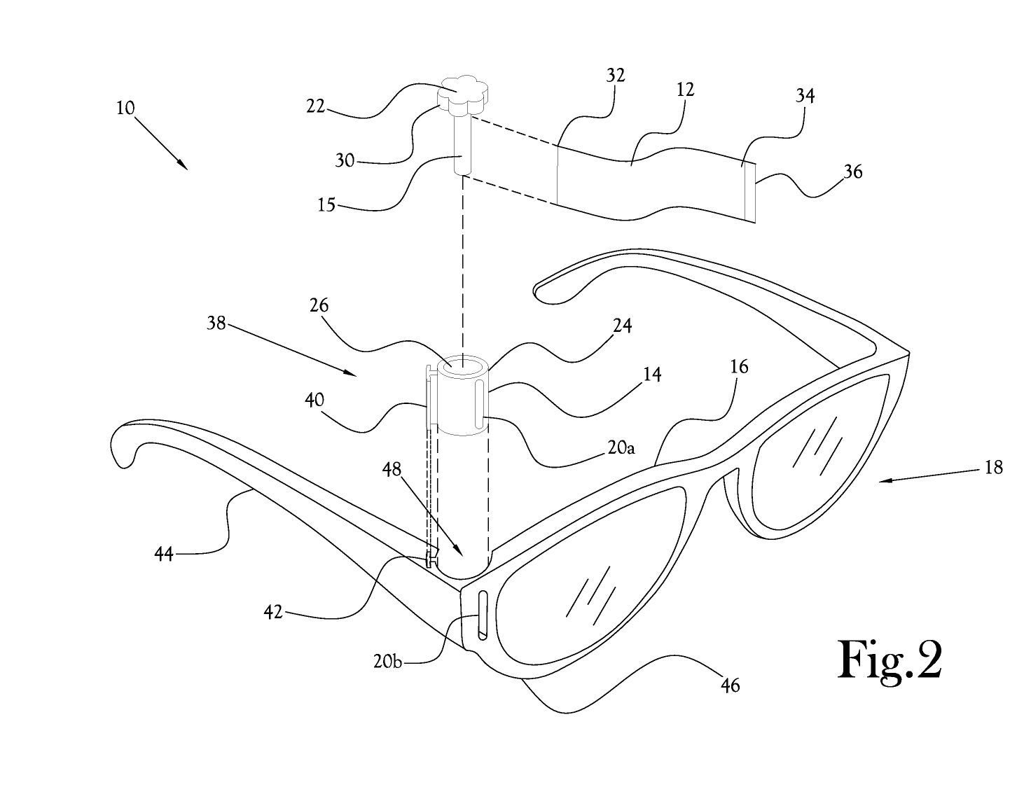

FIG. 1 illustrates a perspective view of one embodiment of an apparatus 10 constructed in accordance with several features of the present general inventive concept, and FIG. 2 illustrates an exploded view of the apparatus of FIG. 1. With reference to FIGS. 1 and 2, in one embodiment, the apparatus 10 includes a housing 14 having a generally cylindrical shape and defining an interior 26. A spool 15 is contained within the housing 14, and in the illustrated embodiment, the spool 15 extends generally along a central axis 28 of the housing interior 26. In several embodiments, the spool 15 is rotatable about the central axis 28 within the housing 14. For example, in the illustrated embodiment, a wheel 22 is mounted at a central location thereof to a first end 30 of the spool 15. The wheel 22 is rotatably mounted at an upper end 24 of the housing 14, exterior of the housing 14, with the spool 15 extending into the interior of the housing 14. Thus, rotation of the wheel 22 about a central axis of the wheel results in rotation of the spool 15 about the central axis 28 of the spool 15 and housing 14. In other embodiments, the spool 15 is rotatably mounted within the housing 14 by way of a spring-loaded mechanism (not shown), such that the spool 15 may be rotated from an initial configuration in a first direction about the central axis 28, whereupon the spring-loaded mechanism urges the spool 15 to rotate in a second direction, opposite the first direction, to return the spool 15 to the initial configuration. Those of skill in the art will recognize other configurations suitable for rotatably mounting the spool 15 within the housing 14, and such configurations may be used without departing from the spirit and scope of the present general inventive concept.

As shown in FIGS. 1 and 2, in several embodiments, a slot 20 is defined by the apparatus 10 to allow access to and from the interior 26 of the housing 14. For example, in the illustrated embodiment, the housing 14 defines a first slot 20a to allow access to and from an interior of the housing 14. As will further be discussed below, the housing 14 is mounted along an interior surface of a frame 16 of a pair of eyewear 18. A second slot 20b is defined along the frame 16 of the pair of eyewear 18, and the housing 14 is mounted along the interior surface of the frame 16 such that the first and second slots 20a, 20b overlie one another. Thus, the first and second slots 20a, 20b cooperate to define a slot 20 which opens to the interior 26 of the housing 14. In other embodiments, the slot 20 may be defined by the housing 14 alone. Furthermore, one of skill in the art will recognize other devices and configurations to allow access to and from the interior 26 of the housing 14.

A sheet of flexible cleaning cloth material 12 is received within the housing 14 and is disposed in a wound configuration about the spool 15. In several embodiments, the sheet of flexible cleaning cloth material 12 is defined by a relatively long, slender ribbon of fabric, and in the illustrated embodiment, the cleaning cloth material 12 is fabricated from a microfiber cloth material of the type commonly employed in eyewear lens cleaning cloths. It will be recognized that numerous other materials are suitable for fabrication of the cleaning cloth material 12, and such materials may be used without departing from the spirit and scope of the present general inventive concept. In the illustrated embodiment, a first end 32 of the cleaning cloth material 12 is secured to the spool 15, and a second end 34 of the cleaning cloth material 12 is received within the slot 20, such that a user may grasp the cleaning cloth material second end 34 and pull the cleaning cloth material 12 through the slot 20, thereby at least partially unwinding the cleaning cloth material 12 from the spool 15 and at least partially removing the cleaning cloth material 12 from within the housing 14. In several embodiments, a tab 36 is secured to the cleaning cloth material second end 34 to assist a user in grasping the cleaning cloth material second end 34. In the illustrated embodiment, the tab 36 is defined by a segment of polymer material having a thickness which is too great to be received within the slot 20. Thus, the tab 36 may not be retracted within the housing 14 by winding the cleaning cloth material 12 about the spool 15, and the tab 36 therefore provides a convenient handle by which a user may grasp the cleaning cloth material second end 34. Those of skill in the art will recognize other suitable devices and configurations to prevent over-retraction of the cleaning cloth material 12 within the housing 14, and such other devices and configurations may be used without departing from the spirit and scope of the present general inventive concept. Furthermore, it will be recognized that inclusion of the tab 36 is not necessary to accomplish the present general inventive concept. For example, in one embodiment, suitable stops are provided to limit rotation of the spool 15 within the housing 14, such that the second end 34 of the cleaning cloth material 12 may not be retracted completely within the housing 14, thus ensuring that the cleaning cloth material 12 may be readily and conveniently accessed by a user.

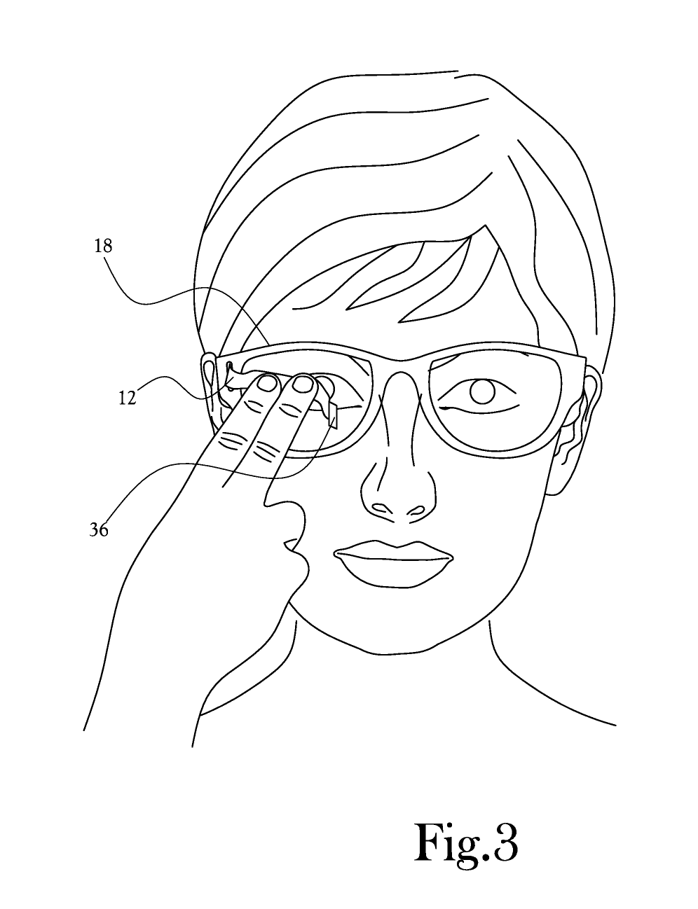

FIG. 3 is a perspective view showing operation of the apparatus 10 of FIG. 1. As shown in FIG. 3, upon pulling the cleaning cloth material 12 to at least partially remove the cleaning cloth material 12 from within the housing 14, the cleaning cloth material may be wiped along a surface of a lens of the eyewear 18 to clean dirt, dust, smudges, liquid, or the like from the lens of the eyewear. Thereafter, the cleaning cloth material 12 may be retracted within the housing 14 by rotating the spool 15, or in some embodiments, by allowing the spool 15 to rotate, as discussed above. Thus, the apparatus 10 may provide a convenient cleaning cloth for a pair of eyewear 18 which is accessible by the user from the eyewear itself, absent the need for the user to carry a cleaning cloth separate from the eyewear 18.

In several embodiments, the housing 14 is securable to a frame 16 of a pair of eyewear 18 via suitable fasteners 38. For example, in the illustrated embodiment, a fastener 38 is provided along an exterior surface of the housing 14 which consists of a substantially elongated rail 40 extending generally parallel to an axial dimension of the housing 14. In the illustrated embodiment, the rail 40 is adapted to be received within a suitably sized and shaped elongated groove 42 defined along a surface of the frame 16 of the pair of eyewear 18. Thus, a mating connection is formed between the housing 14 and the frame 16 of the pair of eyewear 18. In another embodiment, an adhesive fastener is provided between the housing 14 and the frame 16 of the pair of eyewear 18. In still another embodiment, the housing 14 and the frame 16 of the pair of eyewear 18 form an integral connection. Those of skill in the art will recognize numerous additional devices which may be used to accomplish the fastener 38 without departing from the spirit and scope of the present general inventive concept.

According to several features of the present general inventive concept, in several embodiments, the housing 14 is adapted to be secured to the pair of eyewear 18 at an interior location along the frame 16 of the pair of eyewear 18, such that the frame 16 of the eyewear 18 at least partially conceals the housing 14 from visibility external of the frame 16. For example, in the illustrated embodiment, the housing 14 is disposed along an interior surface of the frame 16 of the eyewear 18 along an intersection between one of the temple arms 44 of the frame 16 and an associated rim 46 of the frame 16. More specifically, in the illustrated embodiment, the cylindrical housing 14 defines an axial length approximately equal to a width dimension of the temple arm 44 at the intersection between the temple arm 44 and the rim 46. The housing 14 is received within a cylindrically-shaped cavity 48 in the frame 16 which extends along the interior of the frame 16 along the intersection between the temple arm 44 and the rim 46. Thus, when the housing 14 is mounted to the frame 16 within the cavity 48, the temple arm 44 and the rim 46 of the eyewear 18 cooperate to at least partially conceal the housing 14 from view external of the eyewear 18. Those of skill in the art will recognize other suitable configurations for mounting the housing 14 such that the eyewear 18 operates to at least partially conceal the apparatus 10 from view, and such other configurations may be used without departing from the spirit and scope of the present general inventive concept.

From the foregoing description, it will be recognized by one of skill in the art that an embeddable eyewear cleaning cloth and housing apparatus has been disclosed which provides a cleaning cloth for the lenses of a pair of eyewear which is accessible from the eyewear. The embeddable eyewear cleaning cloth provides a convenient means to clean the lenses of a pair of eyewear absent the need to carry a separate eyewear lens cleaning cloth. In certain embodiments, the embeddable eyewear cleaning cloth and housing apparatus may be mounted on a pair of eyewear such that the embeddable eyewear cleaning cloth and housing apparatus is at least partially hidden by the eyewear. Thus, the embeddable eyewear cleaning cloth and housing apparatus may be worn on a pair of eyewear without degrading the overall aesthetic of the eyewear.

While the present invention has been illustrated by description of several embodiments and while the illustrative embodiments have been described in detail, it is not the intention of the applicant to restrict or in any way limit the scope of the appended claims to such detail. Additional modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

Having thus described the aforementioned invention, what is claimed is:

1. An embeddable eyewear cleaning cloth and housing apparatus for a pair of eyewear, said apparatus comprising:
a housing defining an interior cavity and an opening providing access to and from said interior cavity, said housing being adapted to be secured to a pair of eyewear; and
a sheet of cleaning cloth material disposed within said housing and at least partially removable from said housing through said opening.

2. The apparatus of claim 1, said apparatus further including a spool received within said housing, said sheet being wound about said spool.

3. The apparatus of claim 2, said spool being rotatably secured within said housing.

4. The apparatus of claim 3, said sheet having a first end secured to said spool and a second end protruding through said opening.

5. The apparatus of claim 4 further including a tab secured to a second end of said sheet, said tab being sized to limit receipt of said tab through said opening into said housing interior.

6. The apparatus of claim 5 further including a spring-loaded mechanism associated with said spool, said spring-loaded mechanism allowing rotation of said spool from an initial position of said spool and biasing said spool toward said initial position.

7. The apparatus of claim 5 further including a rotatable handle secured to said spool, whereby rotation of said rotatable handle results in rotation of said spool, thereby allowing winding or unwinding of said sheet about said spool.

8. The apparatus of claim 7 further including a fastener for securing said housing to a frame of a pair of eyewear.

9. The apparatus of claim 8, said fastener being defined by an elongated rail sized and shaped to be received within a groove defined by a frame of a pair of eyewear.

10. The apparatus of claim 8, said fastener being configured to allow said housing to be secured to an interior surface of a frame of a pair of eyewear such that said eyewear at least partially conceals said housing from view external of the eyewear.

11. A pair of eyewear comprising:
a frame for holding at least one at least semi-transparent lens to an eye of a user;
a housing secured to said frame, said housing defining an interior cavity and a first opening providing access to and from said interior cavity; and
a sheet of cleaning cloth material disposed within said housing and at least partially removable from said housing through said first opening.

12. The pair of eyewear of claim 11, said housing being disposed along an interior surface of said frame.

13. The pair of eyewear of claim 12, said frame defining a rim portion and an intersecting temple arm portion, said housing being disposed proximate said intersection between said rim portion and said temple arm portion of said frame.

14. The pair of eyewear of claim 13, said frame defining a second opening overlying said first opening of said housing, said sheet being at least partially removable from said housing through said overlying first and second openings.

15. The pair of eyewear of claim 4, said apparatus further including a spool received within said housing, said sheet being wound about said spool.

16. The pair of eyewear of claim 15, said spool being rotatably secured within said housing.

17. The pair of eyewear of claim 16, said sheet having a first end secured to said spool and a second end protruding through said opening.

18. The pair of eyewear of claim 17 further including a tab secured to a second end of said sheet, said tab being sized to limit receipt of said tab through said opening into said housing interior.

19. The pair of eyewear of claim 18 further including a spring-loaded mechanism associated with said spool, said spring-loaded mechanism allowing rotation of said spool from an initial position of said spool and biasing said spool toward said initial position.

20. The pair of eyewear of claim 18 further including a rotatable handle secured to said spool, whereby rotation of said rotatable handle results in rotation of said spool, thereby allowing winding or unwinding of said sheet about said spool.
